(19) United States
(12) Patent Application Publication
(10) Pub. No.: US 2006/0277221 A1
(43) Pub. Date: Dec. 7, 2006

(54) Transactional file system with client partitioning

(75) Inventors: Tom R. Zavisca, Santa Barbara, CA (US); David Kleidermacher, Goleta, CA (US)

Correspondence Address: DARBY & DARBY P.C., P. O. BOX 5257, NEW YORK, NY, 10150-5257, US

(73) Assignee: Green Hills Software, Inc., Santa Barbara, CA (US)

(21) Appl. No.: 11/142,582

(22) Filed: Jun. 1, 2005

(51) Int. Cl. G06F 17/30

(52) U.S. Cl. 707/201

(57) ABSTRACT

A file system provides access to data on a storage device so that, for a given volume on the device, read-only client partitions and a read-write client partition are presented with separate but related views of the file system state. Moreover, the read-only partitions do not interfere with each other and do not interfere with the read-write partition, while the read-write partition may delay the read-only partitions. Access to file system blocks is provided by way of separate virtualization trees for the read-only partitions and for the read-write partition. A reader tree represents a consistent (but older) file system state. A writer tree, which has a different root pointer from the reader tree and is partially stored in main memory, represents the state of in-progress file system transactions. When a set of file system transactions is committed, the writer tree root pointer is copied to the reader tree root pointer.

### FIELD OF THE INVENTION

The present invention relates generally to data storage for computing devices, and more particularly, but not exclusively, to a transactional file system that supports partitioning of clients.

### BACKGROUND OF THE INVENTION

In a computing system, a file system is the mechanism by which the logical view of data storage is mapped to physical locations on a disk or other storage device. Computing systems are vulnerable to unpredictable failures, such as operating system crashes, hardware failures, and power interruptions. Such events may place a file system within the computing system in an inconsistent state, since tasks involving reading from and writing to files may be in progress when the event occurs and in-memory buffers might not have been written to disk. To preserve the integrity of stored data, file systems have traditionally been designed to write file metadata for use in restoring the file system to a consistent state following a reboot. In these traditional systems, however, a reboot is typically followed by a scan of an entire disk, which typically requires an undesirable length of time to complete. Significant delays in recovering the file system may be unacceptable in certain types of embedded systems, such as safety-critical or mission-critical systems, that require a fast startup or boot time.

Some file systems have been designed to speed up system recovery by maintaining a journal on the storage device that logs metadata and possibly also data relating to file system operations (or “transactions”), including file updates. When metadata is updated, all potentially inconsistent data is recorded in the journal. A set of updates to files does not take effect until a final “commit” of transactions is made from the journal to the storage device.

Transactional file systems as well as traditional file systems suffer from contention among client processes for computing resources, such as processor time and file cache buffers, associated with access to the file system. If a client for a file server makes a system call, such as opening a file for reading and writing, other clients or processes are generally delayed from using those resources at the same time. Mutual exclusion locks, semaphores and similar mechanisms are available to coordinate access to these resources, but in general they do not prevent an operation on behalf of one client, such as a read-only client, to interfere with an operation on behalf of another client, such as a read-write client.

### BRIEF DESCRIPTION OF THE DRAWINGS

For a better understanding of the present invention, reference will be made to the following detailed description, which is to be read in association with the accompanying drawings, wherein:

FIG. 1 is a block diagram illustrating an exemplary operating environment;

FIG. 2 is a block diagram illustrating an initial file system image on a formatted storage device;

FIG. 3 is a block diagram illustrating a logical view of a system for access to data with sets of read-only clients and read-write clients;

FIG. 4 is a diagram illustrating components of a system for access to data with sets of clients;

FIG. 5 is a diagram illustrating the manner in which a file server provides access to a file system;

FIG. 6 is a flow diagram illustrating a process for providing access to file system data to read-only and read-write clients; and

FIG. 7 is a diagram showing a simplified structure of a virtualization tree.

### DETAILED DESCRIPTION

In the following detailed description, reference is made to the accompanying drawings, in which are shown exemplary but non-limiting and non-exhaustive embodiments of the invention. These embodiments are described in sufficient detail to enable those having skill in the art to practice the invention, and it is understood that other embodiments may be used, and other changes may be made, without departing from the spirit or scope of the invention. The following detailed description is, therefore, not to be taken in a limiting sense, and the scope of the invention is defined only by the appended claims. In the accompanying drawings, like reference numerals refer to like parts throughout the various figures unless otherwise specified.

Overview of the Invention

The present invention is directed to a method and system for providing access to data on a storage device so that, for a given volume on the device, read-only clients and read-write clients are presented with separate but related views of a file system state. Clients with read-only access rights to a volume are provided a view of file system state that may be slightly older than that available to read-write clients. In an embodiment, file system clients are grouped into sets or partitions, which have different access rights to each storage device volume: no access, read-only access, and read-write access. For each volume, there is at most one client partition that has read-write access, and there are zero or more read-only client partitions. This concept of partitioning of file system clients is not supported by traditional file systems.

In accordance with an embodiment of the invention, a file system provides the following non-interference property. For a given volume, the read-only client partitions do not interfere with each other and do not interfere with the read-write client partition. A client partition that has read-write access to a volume may delay other partitions that have read-only access to that volume. This non-interference property enables guaranteed levels of service to be provided to client partitions. Moreover, it prevents the illicit flow of information between client partitions (for example, by way of covert channels). These features are important in enhancing the security, safety and reliability of the system.

In one embodiment, the invention includes a transactional file system. For a given volume, access to file system blocks is provided by way of separate virtualization tree data structures for the read-only client partitions and for the read-write client partition. A reader tree, which is stored on a flash memory device, magnetic hard disk, or other nonvolatile or secondary storage device, represents a consistent (but older) file system state. A writer tree, which has a different root pointer from the reader tree and is partially stored in main memory, represents the state of in-progress file system transactions. Read-only client partitions are permitted to see the set of content blocks that are reachable by way of the reader tree. The read-write client partition performs reads and writes by accessing the set of content blocks that are reachable by way of the writer tree. When a content block is modified, that block and the blocks in the writer tree that recursively point to the content block are exchanged with unused journal blocks. When a set of file system transactions is committed, the root pointer of the writer tree is copied to the reader tree root pointer, and journal blocks are reclaimed.

Embodiments of the invention provide a single integrated mechanism which allows for transactional journaling, client partition non-interference as described above, and deterministic allocation and freeing of blocks with no additional overhead. A single integrated mechanism provides efficiency benefits and permits a relatively small file server image, which is particularly advantageous for memory-constrained embedded systems. The invention may be practiced in conjunction with a real-time operating system and with deeply embedded systems that are required to operate under significant constraints relating to memory and processor usage and power consumption, including those used in safety-critical and mission-critical applications. However, the invention is not thus limited. The invention is applicable to the implementation of database systems in addition to file systems.

Exemplary Operating Environment

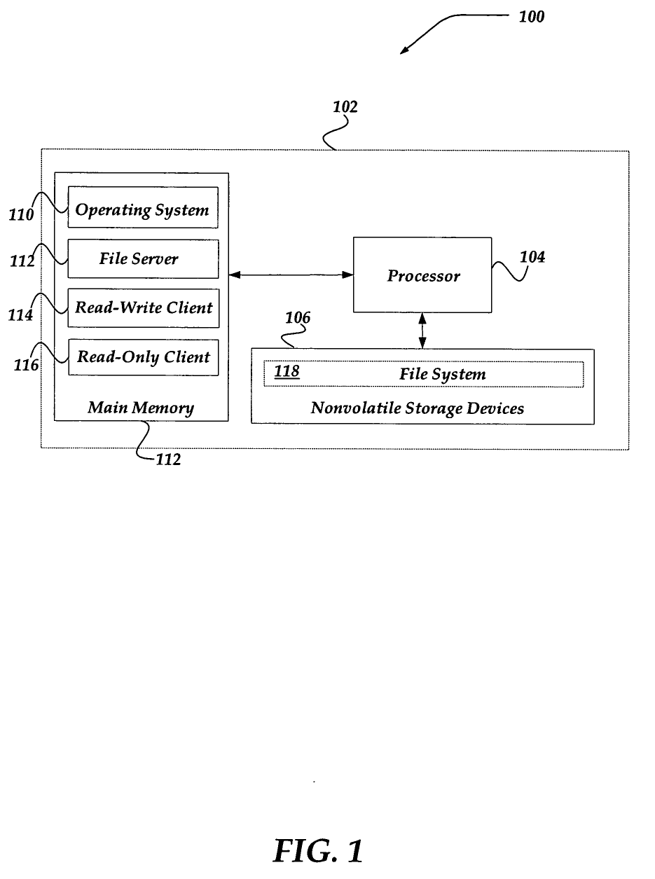

FIG. 1 illustrates an exemplary operating environment 100 suitable for practicing the present invention. It will be noted that not all the components and features depicted are required to practice the invention, and that variations in the arrangement and type of the components may be made without departing from the spirit or scope of the invention. Moreover, as will be appreciated by those skilled in the art, operating environments for practicing the invention typically include many elements not specifically shown in FIG. 1. Exemplary operating environment 100 illustrated in FIG. 1 is neither exhaustive nor limiting, and other embodiments of the invention may be situated within alternative environments.

Environment 100 includes a computing device 102. Device 102 may be a special-purpose or a general-purpose computing device, and may be situated or embedded within another device or apparatus. The features typically present in computing devices of various kinds are well-known and rudimentary to those skilled in the art and need not be depicted in detail or described at length here. Computing device 102 includes, among other components not specifically shown, a processor 104, a main memory 122, and one or more nonvolatile storage devices 106. Storage devices 106 may include, for example, a flash memory device, a magnetic hard disk, or the like. Programs and data may be stored in main memory 122, from which they can be accessed by processor 104. Such programs may include operating system 110, file server 112, read-write client 114, and read-only client 116. Operating system 110 may be a real-time operating system or another kind of operating system. File server 112 mediates access to files for read-write client 114 and read-only client 116. Files are part of file system 118, which comprises a logical view of data physically stored on storage devices 118 and which may be separate from or integrated with operating system 110. A part of a file system in accordance with the present invention may be stored in main memory 122, as is discussed further above and below.

Initial File System Image

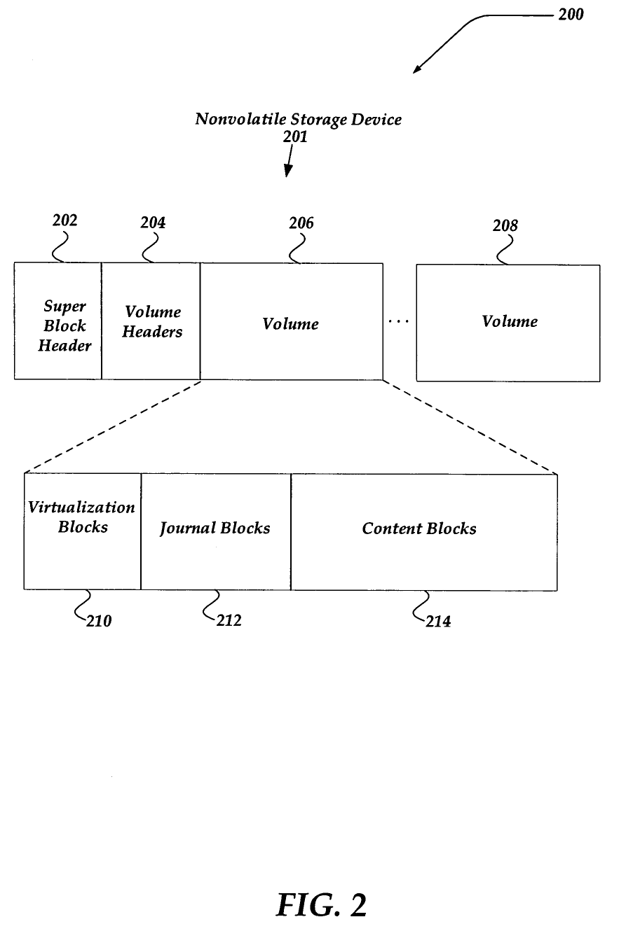

FIG. 2 illustrates the initial formatting 200 of a nonvolatile storage device 201, which may be one of nonvolatile storage devices 106 illustrated in FIG. 1, in accordance with one embodiment of the present invention. A nonvolatile storage device, whether a flash memory device, a hard disk, or another kind of device, typically comprises a set of physical blocks or like physical units capable of storing file system content, file system metadata, and other data used in implementing a file system. A storage device is generally formatted prior to its use with, or as part of, a file system. As shown in FIG. 2, storage device 201 is initially formatted to include header blocks, including superblock header 202 and one or more volume headers 204. Such header blocks may be used in defining one or more volumes on a device, such as volumes 206-208 on storage device 201.

As indicated in FIG. 2, in an embodiment of the invention volume 206 is further formatted for use in implementing a transactional file system. Volume 206 is formatted to include virtualization blocks 210, journal blocks 212, and content blocks 214. Content blocks 214 correspond to the metadata (for example, an inode) and data of a traditional file system. Virtualization blocks 210 are used in implementing a virtualization data structure, which provides virtualized (indirect) access to journal blocks 212 and content blocks 214. Access is indirect or virtualized in that the virtualization data structure is used in mapping a logically-identified block to its actual physical location on the storage device.

In embodiments of the invention, the virtualization data structure is a virtualization tree, which may be implemented as the interior nodes of a balanced tree, such as a B+ tree, or as another kind of tree data structure or component of a tree data structure. On storage device 201, separate but related views of file system state for volume 206 are provided to client partitions having read-only access to the volume and the client partition that has read-write access to the volume by providing the root pointer for a reader virtualization tree and the root pointer for a writer virtualization tree, respectively. The root pointer for the writer virtualization tree is stored within volume headers 204, in the volume header for volume 206. The root pointer for the reader virtualization tree is stored in main memory. The file system state accessed by the read-write client partition represents the state of in-progress transactions. The file system state accessed by read-only client partitions represents, in general, a consistent but older view of the file system and accordingly may coincide with or diverge from the view of the file system seen by the read-write partition.

Client Partitioning

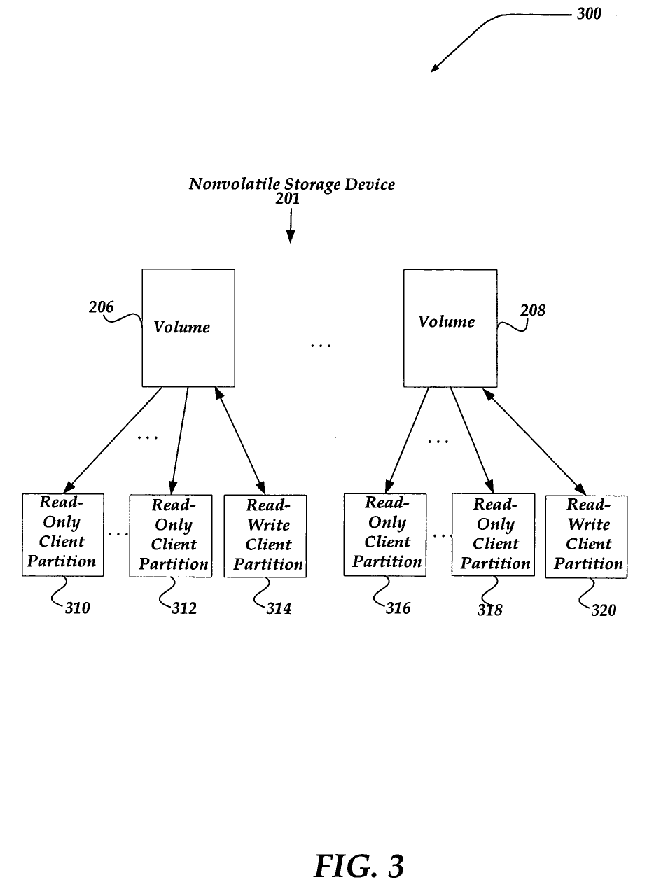

FIG. 3 shows a logical view of a system 300 for access by file system clients to file system data in accordance with one embodiment of the invention. In the exemplary embodiment shown, storage device 201 includes volumes 206-208. File system client processes are grouped into partitions or sets of clients, such as client partitions 310-320 shown in the figure. A client partition has one of the following access rights with respect to each volume: no access, read-only access, or read-write access.

For each volume, such as each of volumes 206-208, there is at most one client partition with read-write access. Thus, as illustrated in FIG. 3, partition 314 has read-write access to volume 206, and partition 320 has read-write access to volume 208. Also, for each volume, there are zero or more read-only client partitions. For example, partitions 310-312 have read-only access to volume 206, and partitions 316-318 have read-only access to volume 208. With respect to volume 206, read-only partitions 310-312 do not interfere with one another and do not interfere with read-write partition 314. Similarly, with respect to volume 208, read-only partitions 316-318 do not interfere with one another and do not interfere with read-write partition 320. As noted elsewhere in this specification, the non-interference property is not strict non-interference in that the read-write client partition for a volume may delay the read-only partitions for that volume. For example, read-write partition 314 may delay read-only partitions 310-312, and read-write partition 320 may delay read-only partitions 316-318.

As noted, client partitions have different access rights for each volume. A client partition may, for example, have read-only access to one volume and read-write access to another volume. For example, read-only client partition 312, which has read-only access to volume 206, may be the same client partition as read-write client partition 320, which has read-write access to volume 208. Each partition is associated with separate memory and CPU resources.

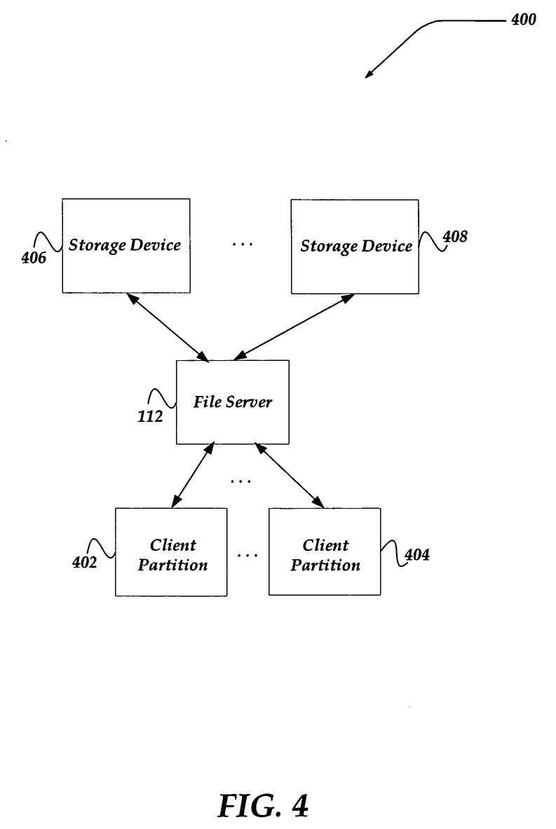

FIG. 4 illustrates components of a system 400 embodying the present invention. As shown in the figure, system 400 includes storage devices 406-408, file server 112, and client partitions 402-404. File server 112 provides client partitions 402-404 with access to the file system associated with volumes on one or more of the storage devices 406-408. As noted elsewhere in this specification, each client partition has a particular access right with respect to each volume (no access, read-only access, or read-write access). With respect to a volume, read-only client partitions do not interfere with each other or with the read-write client partition for the volume, while the read-write client partition may delay the read-only client partitions for the volume.

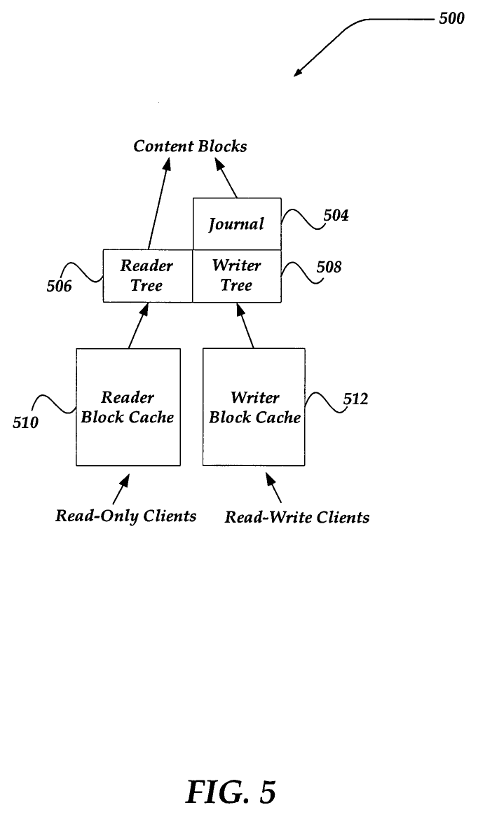

FIG. 5 is a diagram illustrating the manner in which a file server, such as file server 112 of FIG. 4, provides access to a file system to partitioned read-only clients and read-write clients in accordance with the invention. A reader block cache 510 and a writer block cache 512 are separately stored in main memory. If a block requested by a client is not stored in the block cache to which the client has access, the file server provides the client with access to a reader tree 506 or a writer tree 508, as appropriate, by providing a pointer to the appropriate data structure. As noted above, for a particular volume, reader tree 506 and writer tree 508 provide, to read-only client partitions and the read-write client partition respectively, virtualized access to file system content blocks and, with respect to the read-write partition, access to journal blocks 504. Clients in a read-only partition are allowed to see the set of content blocks reachable by way of reader tree 506. Clients in a read-write partition perform reads and writes by accessing the set of content blocks reachable by way of writer tree 508. Reader tree 506 represents an older but consistent file system state, from a transactional journaling perspective. Writer tree 508, which is partially stored in main memory, represents the state of in-progress file system operations.

Providing Access to File System

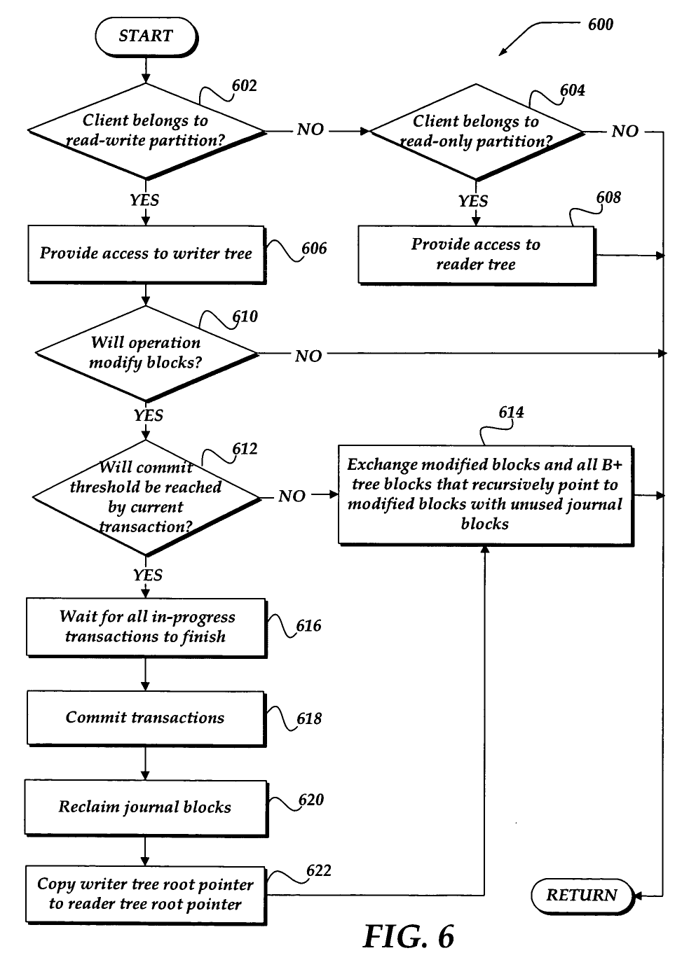

FIG. 6 is a flow diagram illustrating a process for providing access to file system data to clients associated with read-only and read-write client partitions for a storage device volume. The process is initiated, for example, when a client attempts to perform an operation requiring access to the file system. Moving from a start block, process 600 advances to decision block 602, where it is determined whether the client belongs to the read-write partition for this volume. If not, processing branches to decision block 604, where it is determined whether the client belongs to a partition having read-only access to the volume. If not, process 600 returns to perform other processing. If the client belongs to a read-only client partition, process 600 steps to block 608, where the client is provided access to the reader tree for the volume. Process 600 then returns to performing other actions.

If the decision at block 602 is affirmative, the client belongs to the read-write partition for this volume. Process 600 then advances to block 606, where the client is provided access to the writer tree for the volume. Processing then advances to decision block 610, at which it is determined whether the operation is one that may modify one or more blocks. If not (for example, if the operation includes a read call or a lookup of files by name), process 600 flows to a return block and performs other actions. If, however, the operation is a modifying operation, processing advances to decision block 612, at which it is determined whether a commit threshold will be reached as a result of the current file system transaction. The commit threshold is reached, for example, if the journal will be full as a result of the operation.

If the commit threshold will not be reached, process 600 advances to block 614, where modified blocks and all virtualization tree blocks that recursively point to the modified blocks are exchanged with unused journal blocks, if they are not “dirty.” Blocks are exchanged if they have not already been exchanged since the previous commit. It is at this exchange step in block 614 that the reader and writer views of the file system state begin to diverge. Processing then returns to perform other actions.

If the decision at block 612 is affirmative, the commit threshold will be reached, and processing flows to block 616, at which the process waits for in-progress transactions to finish. Process 600 next steps to block 618, at which a commit of transactions occurs. Next, at block 620, journal blocks are reclaimed. Processing then steps to block 622, at which the root pointer for the writer tree is copied to the root pointer for the reader tree. In effect, the read-write client has caused the updates to the file system to be published to all read-only clients for the volume. Process 600 then branches to block 614 where, as noted above, modified blocks and all virtualization tree blocks that recursively point to the modified blocks are exchanged with unused journal blocks, if they are non-dirty. Processing then returns to perform other actions.

As an effect of the journaling process, the body of the virtualization tree (the physical location of the blocks that comprise the tree) moves around the storage device as file system operations occur.

Virtualization Tree

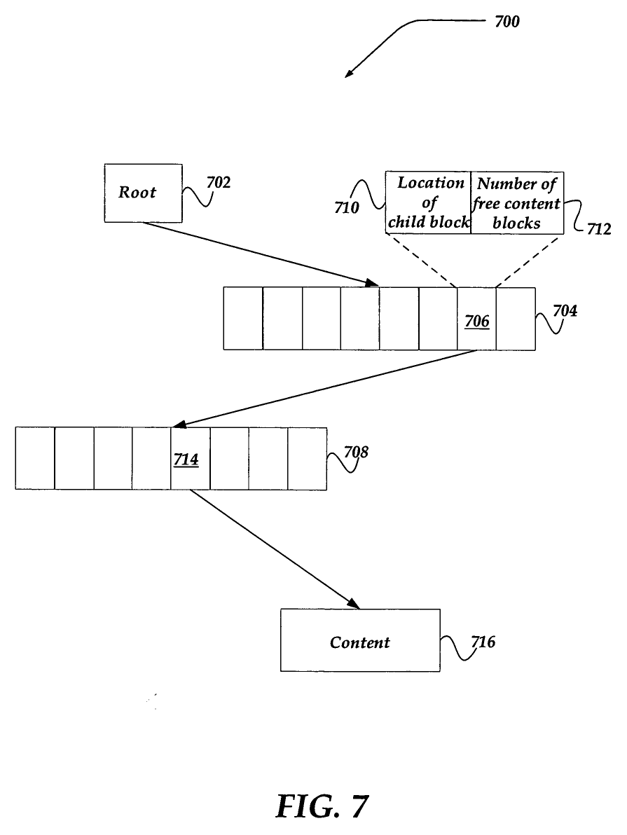

FIG. 7 is a diagram showing, in simplified form, the structure of an exemplary virtualization tree 700 that may be employed as a reader tree or a writer tree in an embodiment of the invention. Tree 700 is located by way of a pointer to a root block 702. As is explained in this detailed description, embodiments of the invention provide two virtualization trees, a reader tree maintained on a nonvolatile storage device and a writer tree that is partially stored in main memory. A virtualization tree may be implemented using a balanced tree, such as a B+ tree or a B tree, or as another kind of tree data structure, and other embodiments of the invention may employ non-tree data structures. The general mechanism by which a B+ tree and similar structures are maintained and searched is understood by those skilled in the art.

A virtualization tree is accessed by way of an associated root pointer. In one embodiment, each node in the virtualization tree is a block comprising an array of branch pointers. As shown in FIG. 7, root block 702 of tree 700 points to virtualization block 704, an internal node in tree 700 containing branch pointers, including branch pointer 706. Branch pointer 706 contains both the location 710 of a corresponding child block, in this case another virtualization block 708, and the number of free (unallocated) content blocks 712 reachable from that child block. As further shown in FIG. 7, block 708 includes a pointer 714 to content block 716, which is a leaf node in virtualization tree 700.

The structure of the branch pointer makes possible a deterministic algorithm for allocating and freeing file system content blocks that is constant with respect to the number of blocks to access. This allows for desirable performance, since a principal factor in the performance of a file system is the number of times a physical read from or write to the storage device is necessary. Because a content block is modified essentially immediately after it is allocated or before it is freed, and all the tree blocks that recursively point to the modified block are treated as dirty along with the modified block, there is no additional cost to allocate or free a content block (in terms of the number of blocks dirtied and, in general, in terms of the number of blocks that are read from the storage device).

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for providing access to data on a storage device, comprising:
providing a first file system state for at least one read-only process;
providing a second file system state for at least one read-write process;
if at least one file system transaction is committed to occur, updating the first file system state to include the second file system state.

2. The method of claim 1, wherein the at least one read-only process is non-interfering with respect to the at least one read-write process, and wherein the at least one read-write process is capable of delaying the at least one read-only process.

3. The method of claim 1, the method further comprising:
grouping client processes into client partitions, wherein each client partition has an access right with respect to each volume on the storage device, and wherein the access right comprises no access, read-only access, or read-write access.

4. The method of claim 3, wherein at least two client partitions have read-only access to a volume, and wherein the at least two client partitions are mutually non-interfering.

5. The method of claim 1, wherein providing the first file system state further comprises maintaining a first set of blocks on the storage device as a first tree and allowing the at least one read-only process to access the first set of blocks, and wherein providing the second file system state further comprises maintaining a second set of blocks as a second tree.

6. The method of claim 5, wherein maintaining the second set of blocks includes storing at least one block in the second set of blocks in a main memory.

7. The method of claim 5, wherein updating the first file system state further comprises copying a root pointer for the second tree to a root pointer for the first tree.

8. The method of claim 5, wherein at least one of the first tree and the second tree is structured as a balanced tree.

9. The method of claim 5, wherein at least one of the first tree and the second tree is structured as a B+ tree.

10. The method of claim 5, further comprising initially formatting a volume on the storage device by allocating a plurality of blocks as a plurality of virtualization tree blocks, a plurality of journal blocks, and a plurality of content blocks.

11. The method of claim 10, further comprising:
if at least one file system transaction is committed to occur, reclaiming used journal blocks.

12. The method of claim 3, further comprising:
with respect to each volume, maintaining a block cache for each client partition that has read-only access to the volume, and maintaining a block cache for a client partition that has read-write access to the volume.

13. The method of claim 10, wherein each virtualization tree block comprises a plurality of pointers, wherein a pointer contains a location of a child block and a number of free content blocks reachable from the child block.

14. A computer-readable medium having computer-executable instructions for enabling access to data on a storage device, the instructions comprising:
providing a first file system state for at least one read-only process;
providing a second file system state for at least one read-write process;
if at least one file system transaction is committed to occur, updating the first file system state to include the second file system state.

15. A method for enabling access to data on a storage device, the method comprising:
grouping file system client processes into a plurality of client partitions;
with respect to a volume on the storage device, assigning an access right to each client partition, wherein the access right comprises no access, read-only access, or read-write access; and
with respect to a volume having a read-write client partition and one or more read-only client partitions,
ensuring that the one or more read-only client partitions are non-interfering with respect to the read-write client partition;
ensuring that the one or more read-only client partitions are mutually non-interfering; and
allowing the read-write client partition to delay the one or more read-only client partitions.

16. A computer-readable medium having computer-executable instructions for enabling access to data on a storage device, the instructions comprising:
grouping file system client processes into a plurality of client partitions;
with respect to a volume on the storage device, assigning an access right to each client partition, wherein the access right comprises no access, read-only access, or read-write access; and
with respect to a volume having a read-write client partition and one or more read-only client partitions,
ensuring that the one or more read-only client partitions are non-interfering with respect to the read-write client partition;
ensuring that the one or more read-only client partitions are mutually non-interfering; and
allowing the read-write client partition to delay the one or more read-only client partitions.

17. The method of claim 16, wherein the storage device comprises at least two volumes, wherein assigning the access right to each client partition further comprises:
assigning to each partition a first access right with respect to a first volume and a second access right with respect to a second volume.

18. A computer-readable medium having computer-executable instructions for enabling access to data on a storage device, the instructions comprising:
grouping file system client processes into a plurality of client partitions;
with respect to a volume on the storage device, assigning an access right to each client partition, wherein the access right comprises no access, read-only access, or read-write access; and
with respect to a volume having a read-write client partition and one or more read-only client partitions, ensuring that the one or more read-only client partitions are non-interfering with respect to the read-write client partition;
ensuring that the one or more read-only client partitions are mutually non-interfering; and
allowing the read-write client partition to delay the one or more read-only client partitions.

19. An apparatus for storing and updating data on a storage device, comprising:
a main memory;
the storage device; and
a processor coupled to the main memory and the storage device, wherein the processor is configured to enable actions, comprising:
providing a first file system state for at least one read-only process;
providing a second file system state for at least one read-write process;
if at least one file system transaction is committed to occur, updating the first file system state to include the second file system state.

20. The apparatus of claim 19, wherein the storage device is a flash memory device.

21. The apparatus of claim 19, wherein the storage device is a magnetic disk.

22. An apparatus for enabling access to data on a storage device, comprising:
a main memory;
the storage device; and
a processor coupled to the main memory and the storage device, wherein the processor is configured to enable actions, comprising:
grouping file system client processes into a plurality of client partitions;
with respect to a volume on the storage device, assigning an access right to each client partition, wherein the access right comprises no access, read-only access, or read-write access; and
with respect to a volume having a read-write client partition and one or more read-only client partitions,
ensuring that the one or more read-only client partitions are non-interfering with respect to the read-write client partition;
ensuring that the one or more read-only client partitions are mutually non-interfering; and
allowing the read-write client partition to delay the one or more read-only client partitions.

23. A computer-readable medium having computer-executable instructions for storing a data structure that enables access to a file system, comprising:
a first tree available to at least one client process having read-only access to a volume on a storage device, wherein the first tree has a first root pointer; and
a second tree available to at least one client process having read-write access to the volume, wherein the second tree has a second root pointer, and wherein the first root pointer and the second root pointer are stored in separate locations.

24. The computer-readable medium of claim 23, wherein the first tree is available to one or more partitions of client processes having read-only access to the volume, and wherein the second tree is available to a read-write partition that includes the at least one client process having read-write access to the volume.

25. The computer-readable medium of claim 23, wherein the first tree comprises blocks on the storage device, and wherein at least one node in the second tree is stored in a main memory.

26. The computer-readable medium of claim 23, wherein the file system is a journaling file system.

27. The computer-readable medium of claim 23, wherein the file system is a transactional file system.

28. The computer-readable medium of claim 23, wherein at least one of the first tree and the second tree is a balanced tree.

29. The computer-readable medium of claim 23, wherein at least one of the first tree and the second tree is a B+ tree.

30. The computer-readable medium of claim 23, wherein the first tree enables access to a first file system state, and wherein the second tree enables access to a second file system state.

31. The computer-readable medium of claim 30, wherein, if at least one file system transaction is committed to occur, the first file system state is updated to include the second file system state.
